(19) United States
(12) Patent Application Publication
(10) Pub. No.: US 2003/0193518 A1
(43) Pub. Date: Oct. 16, 2003

(54) System and method for creating interactive content at multiple points in the television prodction process

(76) Inventors: Scott G. Newnam, Manhattan Beach, CA (US); Izet Fraanje, Santa Monica, CA (US); Douglas T. Neumann, Santa Monica, CA (US); Jeff Gorder, Santa Monica, CA (US); Katharine Brown, Santa Monica, CA (US)

Correspondence Address: Michael A. Diener, Hale and Dorr LLP, 60 State Street, Boston, MA, 02109, US

(21) Appl. No.: 10/118,522

(22) Filed: Apr. 8, 2002

(51) Int. Cl. G09G 5/00

(52) U.S. Cl. 345/719; 345/723

(57) ABSTRACT

A system and method for producing content for episodes of an interactive program that allows content creation during script writing and editing, film editing, after film editing, and in live production, and for content production, responsive to inputs from script writing software and non-linear editing software as well as direct user inputs, for storing content, presentation, and behavior information using an XML schema.

### BACKGROUND OF THE INVENTION

The present invention relates to a system and method for creating episodes with enhanced content, including interactive television programs.

Interactive television programs have existed for several years. The programs span all genres of television programming. Turner Broadcasting System (TBS), for example, has provided enhanced programming for the situation comedy series Friends, and the movie program Dinner & A Movie. Several networks have provided enhanced TV productions of game shows, including Game Show Network's enhanced programming for Greed and Comedy Central's enhanced version of Win Ben Stein's Money. Reality shows have also been enhanced, including CBS's Survivor and The WB's Popstars.

Current methods of creating interactive television programs create interactive content after an episode is complete and edited, and then use time codes to identify when the content will be provided.

### SUMMARY OF THE INVENTION

The embodiments of the present invention are for creating enhanced content for broadcast events, including events broadcast over television, radio, Internet, or other medium. Television is used herein as a primary example for descriptive purposes, but the description applies in most instances to the other media as well. In the case of television, for example, the embodiments of the present invention allow interactive content to be created concurrently with the production of the related primary video episode of the television program at pre-finalized stages, such as during writing, filming, and editing. Content can further be provided after the episode is finalized, and also on-the-fly during broadcast.

An embodiment of the present invention includes at least some of the following components: a script writing component that is capable of managing both primary video scripts and text for interactive content; a post production editing component, which allows the insertion and management of interactive content or references to interactive content; a content tool, which manages the graphics and/or video, text, and functionality of multiple moments of interactive content, each associated with a point in the primary video stream; and a simulator for testing a completed episode. The system can be customized so that completed interactive event output files make up the required components for events on various interactive television systems.

An example of an interactive television system that could run the events created with the present invention is a system in which there is a user-based hardware device with a controller (such as a personal computer), server-based interactive components, and a technical director for interacting with the server components and the user-based hardware device via the server. Examples of such as system and aspects thereof are described in a co-pending applications, Ser. No. 09/804,815, filed Mar. 13, 2001; Ser. No. 09/899,827, filed Jul. 6, 2001; Ser. No. 09/931,575, filed Aug. 16, 2001; Ser. No. 09/931,590, filed Aug. 16, 2001; and Ser. No. 60/293,152, filed May 23, 2001, each of which is assigned to the same assignee as the present invention, and each of which is incorporated herein by reference. These applications include descriptions of other aspects, including different types of content, hardware devices, and methods of delivery of content.

A content creation system according to an embodiment of the present invention defines an alias that distinguishes each poll, trivia question, fun fact, video clip, or other piece of content (“content assets”) from others in the same episode. The alias could be a generic identifier (e.g., “poll number 5”), or a more descriptive identifier (e.g., “poll about favorite show”). This alias can be associated with a location of a script or in a video stream (whether edited or not) without reliance on a time code of a final video master. Once primary video editing is finalized, the alias can be further associated with the time code of the primary video. The interactive content associated with a point in the primary video can be pushed to the user hardware device of the interactive television system automatically at the related point in the primary video feed. Some interactive content assets can be reserved without association to a particular point in the video feed to be pushed on-the-fly based on a director's initiative or the direction of a live program.

There are several potential advantages to producing interactive content concurrent with pre-finalized stages, such as script writing, filming, and editing. The creative talent that is writing the script can be employed to write the interactive content text as well. This approach can be cost effective, save time, and lead to a consistent voice through the primary video (television broadcast) and the interactive content. Another advantage is that film not used in the primary video can be edited and used as interactive content to provide alternative camera angles, outtakes, etc. Still another advantage is that the writers, director and producer may have access to interesting information related to the show, characters, filming, etc. that would make compelling interactive trivia questions or fun facts.

Another aspect of the present invention includes a method for describing elements and attributes of interactive content that can be used to allow input from multiple content creation tools used at multiple points in a television production process for use by participants on multiple interactive television systems and using various user hardware devices and software. In one embodiment, Extensible Markup Language (XML) is used to describe the basic components of an interactive television (ITV) application: content, presentation (look and feel), and behavior (logic). The description of the content can be an object displayed as text, pictures, sounds, video, or a combination of these. The description of the presentation includes location on the screen, text styles, background colors, etc. The behavior description includes what actions happen initially and what happens in reaction to the particular user action or lack of action.

Another aspect of the present invention includes a content production interface responsive to inputs from one or more of script writing software, non-linear editing software, and direct user inputs, to store content, presentation, and behavior information using an XML schema.

Other features and advantages will become apparent from the following detailed description, drawings, and claims.

### BRIEF DESCRIPTION OF THE DRAWINGS

FIG. 1 is a schematic representation of different elements of content production.

FIG. 2 provides an overview of different steps in the content production process.

FIG. 3 is a block diagram of the high-level components in an ITV system.

FIG. 4 is a block diagram of the components in an ITV system specifically focusing on the content production components.

FIG. 5 is an exemplary interface to produce content for ITV content and the resulting XML schema in the DataEngine.

FIG. 6 is a flow diagram of producing a presentation description for an Interactive TV application.

FIG. 7 is an example of a frame within the presentation description.

FIG. 8 is an example of panels within the presentation description.

### DETAILED DESCRIPTION

Conceptually, an interactive television (ITV) application can be broken into three main components: Content, Presentation (look and feel), and Behavior (logic).

ITV programming applies to many different areas and includes applications such as video on demand (VOD), virtual channels, Enhanced TV, and T-commerce with a “walled garden” approach. At a high level, the concept of the different components can be applied to any of these applications. Consider an application from an end-user's experience:

Content: can be a question, graphic, requested video, a purchase item, a piece of information, etc.

Presentation: the content is presented in a certain way: e.g. the question has fontsize=18, color=#FF0000, displayed in the bottom panel, color=# . . . , the video in the upper right corner etc.

Behavior: the application behaves in a certain way based on an end-user's action or lack thereof: e.g., an end-user clicks to purchase an item, to answer question and receive points or order a video.

The content production component of ITV programming is ongoing and by its nature typically changes most frequently. For an enhanced TV application, for example, content can change on an episode by episode basis (the term “episode” is used to denote one instance of an ITV program—a grouping of specific content and interactive assets). An episode can contain items such as trivia question and answers, location ids, points, duration, images, hyperlinks etc. An episode can refer to one in a series of episodes, or can be a unique event.

Although it depends on the ITV programming, the presentation description typically changes less frequently than the content (in case of enhanced TV, content typically changes across episodes, but the presentation description might stay very similar or the same).

The presentation covers everything related to the look and feel of a show. It includes elements such as location options for interactive assets, type of interface (on screen right-side L-shape, left-side L-shape, overlay in bottom), colors, fonts, and font or windows sizes.

The behavior is application specific and contains application specific logic. It includes items such as the specific scoring mechanism for a show or game-logic. In looking at this behavior component in more detail, this logic can reside on the client (in software or middleware on users' hardware device), on the server side (software on the interactive television system's servers), or both. In other words the scoring model for an interactive application might compute the score locally, centrally, or both. This model depends on the platform, the type of application, and the back-end systems. Furthermore the actual logic/behavior is specific to the type of application.

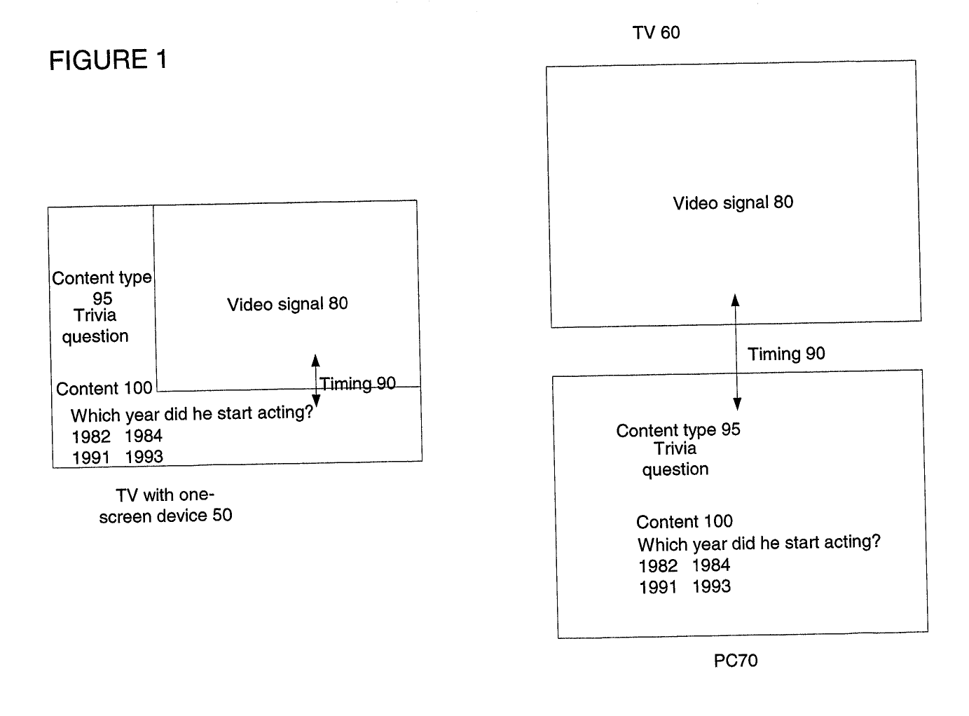

FIG. 1 shows an enhanced TV application interface, with one-screen and two-screen applications. In the first example, the end-user has an integrated TV and set-top experience (a TV with one-screen device 50), while in the second example the user has a TV 60 and a PC 70 with separate displays. In either case a content item in an ITV application is defined by multiple attributes: (1) synced Timing 90—linking content item to certain frame in the broadcast, (2) Content type 95—determine the type of content (e.g., trivia or poll), and (3) Content 100—the actual content itself (e.g., text, graphic, sound clip, or video clip).

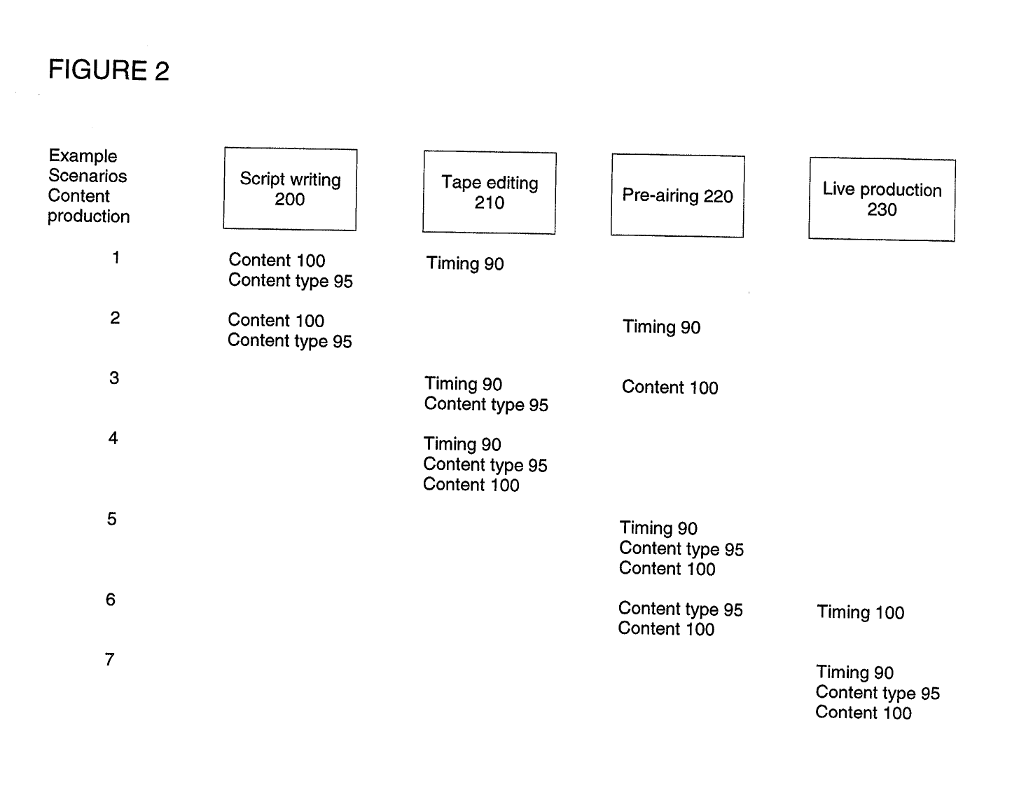

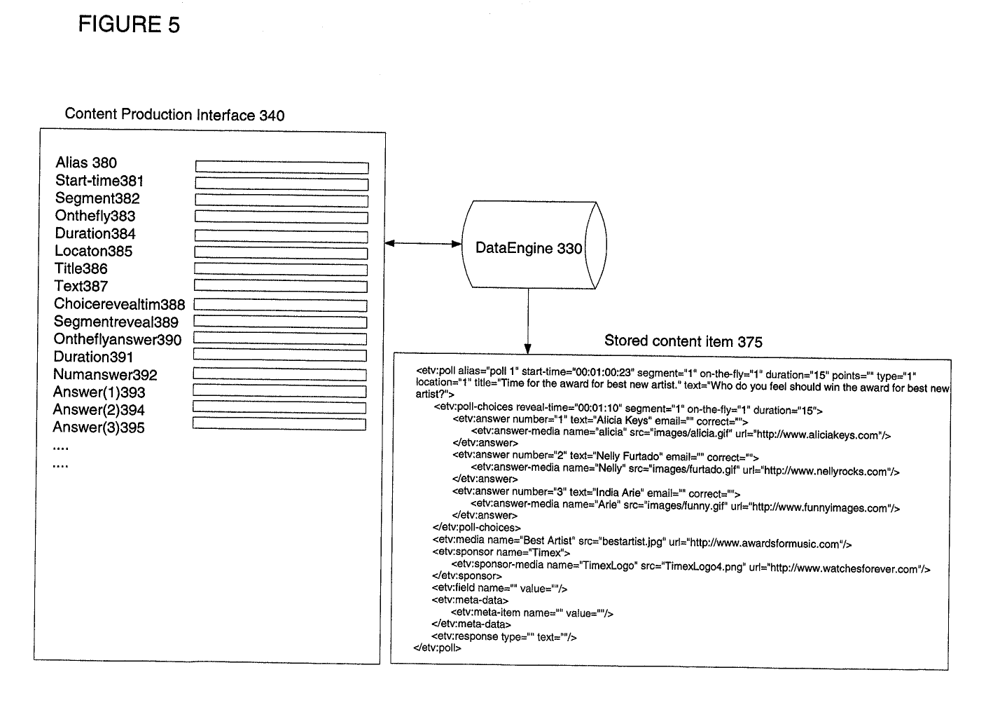

As depicted in FIG. 2, ITV content can be produced at different stages of the production process, both before and after the episode is finalized as to its broadcast content, such as during (a) Script writing 200, (b) Tape editing 210, (c) Pre-airing 220, and (d) Live production 230. The Timing 90 and Content types 95 can also be decoupled and defined at different points in the process as shown in FIG. 1. The Timing 90 of interactive content, for example, can be determined by adding markers during the video editing process to indicate interactive content. A file with these markers can be exported and form the basis for Stored content item 375 (as shown in FIG. 5). The actual interactive Content 100 can be associated with the Timing 90 later on in the process. The reverse order can also be applied.

The writers of the TV show can determine what the ITV Content 100 and Content type 95 could be while producing the TV show. Once a final tape is produced the Timing 90 can be associated with the interactive content assets that were already written in an earlier stage. In a live production situation, Content 100 can be pre-created and the Timing 90 can be entered live, while in another case both Timing 90 and Content 100 might be created in real-time.

The content thus has an alias that distinguishes each poll, trivia question, fun fact, video clip, or other piece of content (“content assets”) from others in the same episode. The alias could be a generic identifier (e.g., “poll number 5”), or a more descriptive identifier (e.g., “poll about favorite show”). This alias can be associated with a location of a script or video stream (whether edited or not) without reliance on a time code of a final video master. Once primary video editing is finalized, the alias can be further associated with the time code of the primary video. The interactive content associated with a point in the primary video can be pushed to the user hardware device of the interactive television system automatically at the related point in the primary video feed. Some interactive content assets can be reserved without association to a particular point in the video feed to be pushed on-the-fly based on a director's initiative or the direction of a live program.

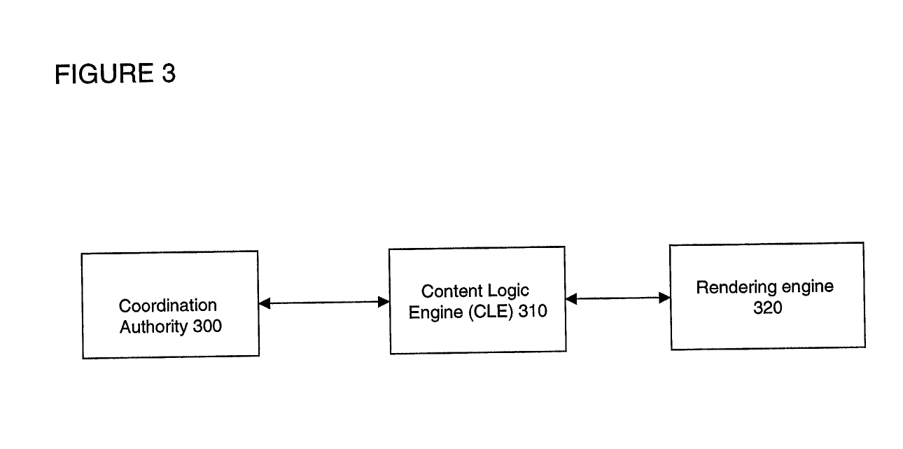

FIG. 3 shows components of an ITV system. The Coordination authority 300 is a back-end system that contains one or more servers and other components that perform processing. The Content Logic Engine 310 (CLE 310) is responsible for interpreting information coming from the Coordination authority 300 and responsible for generating content to display on the screen. The exact role of the CLE 310 will depend upon the purpose of the application, but may include communication with a remote agent, caching content for later display, and managing local data for the client. The Rendering engine 320 is responsible for rendering the content generated by the CLE 310. The role of the CLE 310 can be performed on both the server side and the client side.

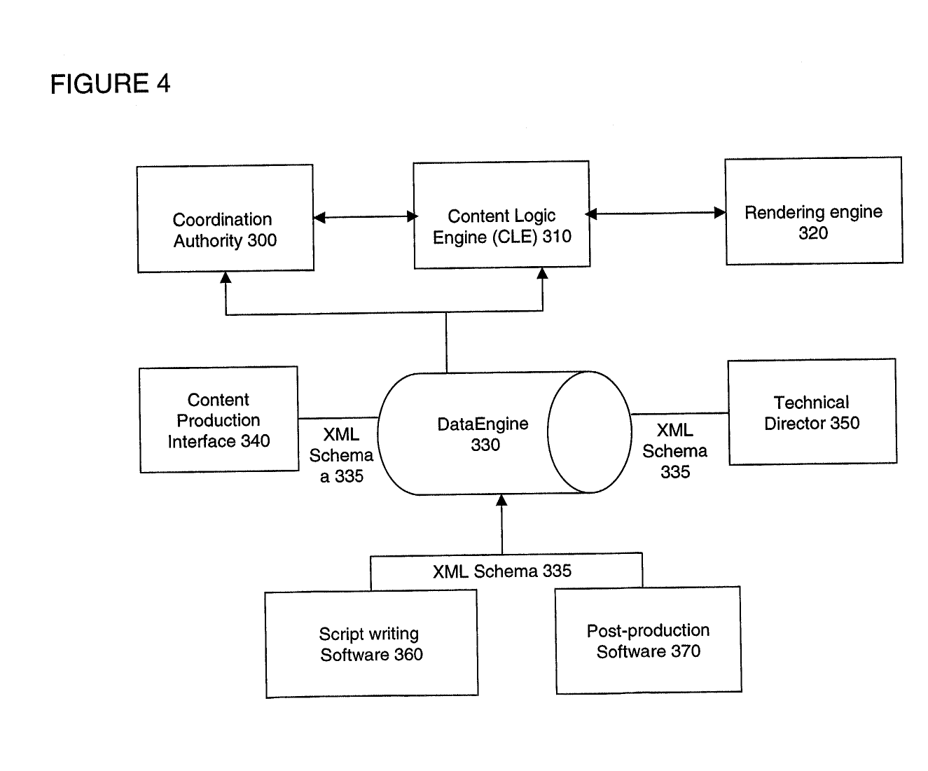

As shown in FIGS. 4 and 5, a DataEngine 330 provides a central source for storage of ITV content. The content can be produced using the Content Production Interface 340 while items can also be exchanged with other interfaces (e.g., Script writing software 360 and Post-production software 370, also known as non-linear editing software). These other interfaces can have the ability to enter information that looks like interface 340, or that is tailored to the underlying software. The Technical Director 350 can be used for creating and/or inserting live (on the fly) content production. The import of data to and export of data from the DataEngine 330 is preferably performed in accordance with an XML schema 335.

For example, script writing software can include an ability whereby a writer selects “create asset” (e.g., with a function key or an icon), causing a new window to open with an interface for fields similar to those in content production interface 340 to allow the writer to enter information about the content asset to be created. Later, the content asset can be edited. This interface allows easy insertion into the script and allows the writer to add during the script creation process. This ability to create the content asset with an alias allows the content asset to more easily be associated with a point in the filming and/or editing process, and allows the writer to create content while also creating a script.

Referring particularly to FIG. 5, an example is shown of Content Production Interface 340 used to enter ITV content into DataEngine 330. This example is a trivia question with three answers to select from, and includes start and duration time, and other information relating to presentation of the question. The interface has specifically identified fields 380-395 for entering information. Alias 380 is used to identify the piece of content, such as “poll 5” or “trivia question about lead actor's hometown.” Stored content item 375 provides an example of a format in which this content is stored and can thereafter be exchanged with different interfaces in the production process as set out in FIGS. 2 and 4. A more extended XML schema and Document Type Definition (DTD) information that describe a content production format are in the example below. The pieces of information are entered through an interface, and then are stored in XML format for later use.

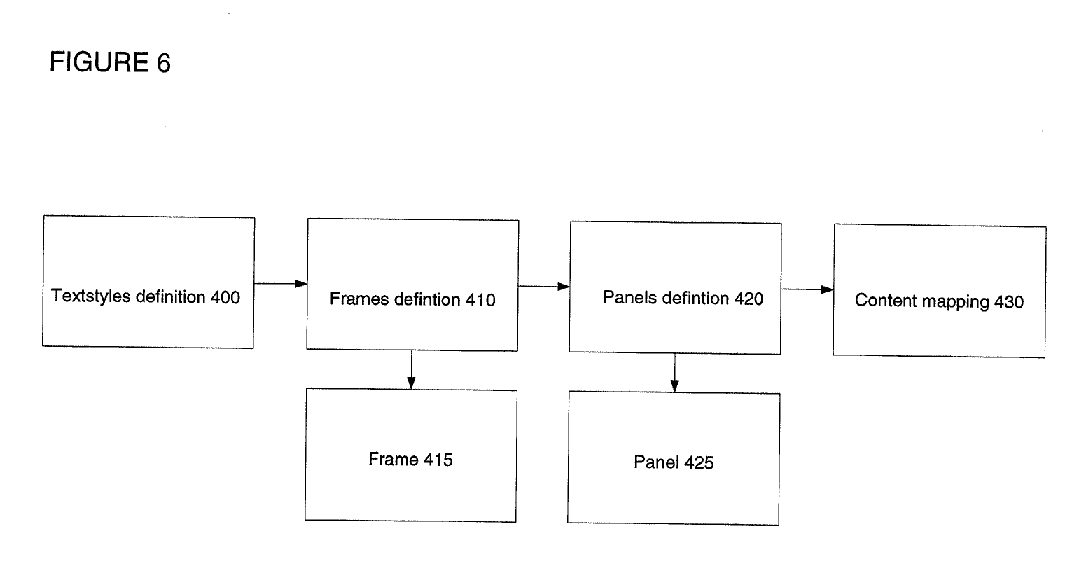

FIG. 6 is a flow diagram to produce the presentation description of an ITV application. The process starts with determining Textstyle definitions 400. The Textstyle definitions 400 provide a mechanism for defining monikers for various text attribute sets. A single text style definition is composed of one or more attribute sets listed in order of decreasing priority. This system simultaneously creates content for multiple client applications (i.e., types of software, middleware and hardware configurations used by different users). Therefore, the client applications' Client logic engines 310 (CLE 310) must determine which attribute set is most appropriate for its platform. The client application should attempt to accommodate an attribute set as close as possible to the top of the list.

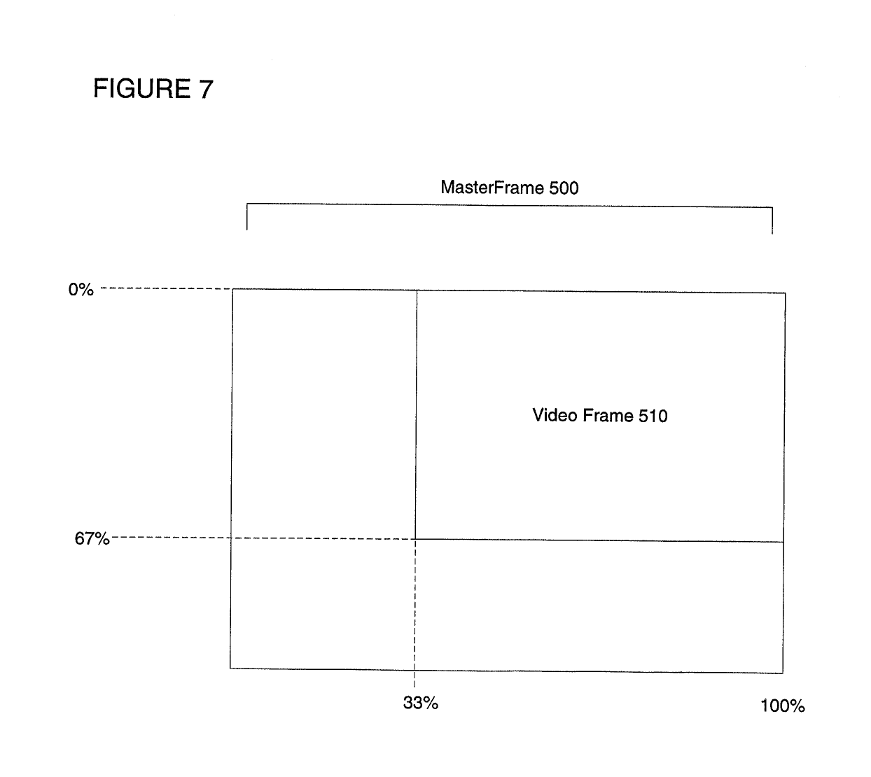

The next step is to determine Frame definitions 410. The Frame definition 410 breaks the screen up into regions where content will be displayed. The Frame definition 410 does not provide any description of the content that will be displayed in these regions; this is the role of panels described in the next section. Frame definitions 410 simply define screen regions, Frames 415, and any appropriate background attributes for those regions. Frame definitions 410 are hierarchical which allows for layering of frames. One frame is a top-level Frame, called a Master frame 500 (FIG. 7), that always encompasses the entire screen. All other frames are “children” of this Master frame 500.

The third step is to determine Panel definitions 420. A Panel definition 420 describes the layout and formatting of content that is displayed in the regions defined by the frame definition 410. Panels 425 also provide a transitioning mechanism for migrating content into and out of an application based on predetermined criteria. Panels 425 are not defined hierarchically as are Frames 415. Any second, third, or higher order effects desired in the display must be achieved with Frames 415.

Each Panel 425 is mapped to a single Frame 415, and only one panel can occupy a Frame 415 at a given time. Panels 420 are composed of text fields, images, various input fields, and buttons. When content is to be displayed on a Panel 425, the content fields are mapped into the panel based on keyword substitutions. The keywords to be substituted are defined by the content type.

Panels 425 are defined with zero or more sets of criteria for ending the display. These are called “tombstone criteria.” A Panel 425 that is displayed on screen remains on screen until a new Panel 425 takes possession of the same Frame 415, or until one of the tombstone criteria is met. Panel tombstones can be defined with a “nextpanel” attribute that allows for another panel 425 to be transitioned onto a Frame 415 when the tombstone criterion is met.

The fourth step is content mapping. The Content mapping 430 is used to associate content produced by the CLE 310 with panels used to display the content. It consists of a series of map entries defining Panels 420 to render when content should be displayed. It also contains a series of assertions intended to allow content of the same type to be rendered differently based on various parameters.

FIG. 7 gives a specific example of Frames 415. It has a master frame 500 and video frame 510. The presentation description XML representing this figure is as follows:

<itv:frame name=“master” bgcolor=“#FF0000” display=“persist”>

<itv:frame name=“video” bgimage=“tv:” top=“0” left=“33%”
bottom=“67%” right=“100%”/>

</itv:frame>

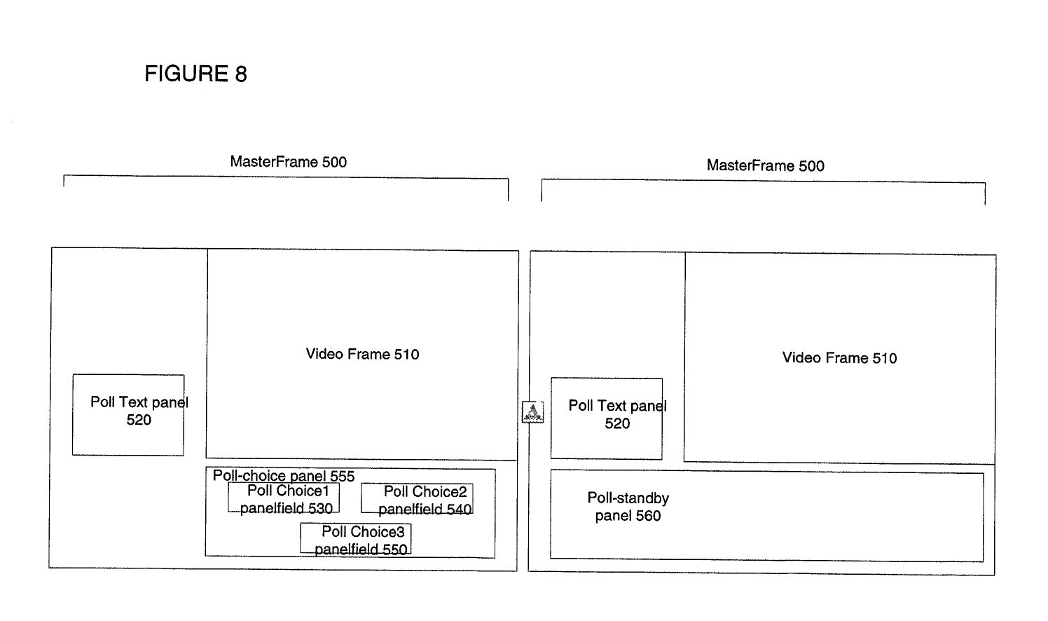

FIG. 8 provides an example of panels 420. It shows a Poll text panel 520, three Poll choice panels (530, 540, and 550), and a Poll standby panel 560, which replaces the poll choice panels once a poll choice has been selected. Examples of the presentation description XML representing each panel is shown below.

The Poll Text Panel 520:

<itv:panels>

<itv:panel name=“poll_text” frame=“text”>

<itv:panelfield top=“15%” left=“0” right=“100%”
bottom=“85%”

justify=“left” textstyle=“general”>
<itv:sub value=“poll/text”/>

</itv:panelfield>

</itv:panel>

The Poll Choice 1, 2 and 3 Panels 530, 540 and 550:

<itv:panel name=“poll_choices” frame=“bottom”>

<itv:tombstone criteria=“onClick38 action=“pollChosen”
nextpanel=“poll_{—} standby”/>
<itv:panelfield top=“25%” left=“25%” right=“50%”
bottom=“50%” justify=“center” textstyle=“general”>

<itv:paneltext>

<itv:sub value=“poll/answer[1]/text”/>

</itv:paneltext>
<itv:click-data action=“pollChosen”>

<poll-choice value=“1” />

</itv:click-data>

</itv:panelfield>
<itv:panelfield top=“25%” left=“50%” right=“75%”
bottom=“50%” justify=“center” textstyle=“general”>

<itv:paneltext>

<itv:sub value=“poll/answer[2]/text”/>

</itv:paneltext>
<itv:click-data action=“pollChosen”>

<poll-choice value=“2”/>

</itv:click-data>

</itv:panelfield>
<itv:panelfield top=“50%” left=“36%” right=“64%”
bottom=“75%” justify=“center” textstyle=“general”>

<itv:paneltext>

<itv:sub value=“poll/answer[3]/text”/>

</itV:pafneltext>
<itv:click-data action=“pollChosen”>

<poll-choice value=“3”/>

</itv:click-data>

</itv:panelfield>

</itv:panel>

The Poll Standby Panel 560

<itv:panel name=“poll_standby” frame=“bottom”>

<itv:panelfield top=“0” left=“0” right=“100%”
bottom=“100%” justify=“left” textstyle=“general”>

<itv:paneltext>Waiting for others to answer...
</itv:paneltext>

</itv:panelfield>

</itv:panel>

</itv:panels>

The engines, interfaces, tools, technical directors, and other processes and functionalities can be implemented in software or a combination of hardware and software on one or more separate general purpose or specialty processors, such as personal computers, workstations, and servers, or other programmable logic, with storage, such as integrated circuit, optical, or magnetic storage.

EXAMPLE

[image]

What is claimed is:

1. A method for creating an interactive video program comprising:
creating an episode file with a number of content assets, each asset including one or more of text, graphics, video, and functionality; and
associating each content asset with a location in a script and/or pre-finalized video stream.

2. The method of claim 1 further comprising, when the video stream is finalized, associating the content assets with a time code in the video stream.

3. The method of claim 1, wherein at least some of the content assets are associated with the video stream at the time the script is created using a script writing tool and/or an interactive content tool.

4. The method of claim 1, wherein at least some or all of the content assets are associated with the video stream at the time the video stream is edited using video editing post-production equipment and/or an interactive content tool.

5. The method of claim 1, wherein at least some of the content assets are associated with the video stream after the video stream is edited using video editing post- production equipment and/or an interactive content tool.

6. The method of claim 1, wherein additional content assets are associated with the video stream after editing.

7. The method of claim 1, wherein the video stream is part of a television program, and the interactive content is created during multiple points in the television production process for use by participants on multiple interactive television systems and using various user hardware devices and software.

8. The method of claim 7, wherein each content asset is used to describe the content, presentation, and behavior of an interactive application.

9. The method of claim 8, wherein a description of the content can be an object displayed as a combination of one or more of text, pictures, sounds, and video.

10. The method of claim 8, wherein the description of the presentation includes location on the screen, text styles, and background colors.

11. The method of claim 8, wherein the behavior description includes what actions happen initially and what happens in reaction to a particular user action and/or lack of action.

12. The method of claim 7, wherein XML is used to describe at least of the following components of an interactive television application: content, presentation, and behavior.

13. The method of claim 12, wherein the description of the content can be an object displayed as a combination of one or more of text, pictures, sounds, and video.

14. The method of claim 12, wherein the description of the presentation includes location on the screen, text styles, and background colors.

15. The method of claim 12, wherein the behavior description includes what actions happen initially and what happens in reaction to the particular user action or lack of action.

16. The method of claim 1, further comprising providing to remote user hardware devices the content assets to allow a user to view and respond to the interactive content in the episode file.

17. A content production system including an interface, responsive to inputs from one or more of script writing software, non-linear editing software, and direct user inputs, and storage for storing content, presentation, and behavior information using an XML schema.

18. The content production system of claim 17, wherein the interface is responsive to inputs from script writing software.

19. The content production system of claim 17, wherein the interface is responsive to inputs from non-linear editing software.

20. The content production system of claim 17, wherein the interface is responsive to direct user inputs.

21. The content production system of claim 18, wherein the script writing software has the ability to open a window during script-writing and to create or edit a content asset.

21. A method for creating an interactive broadcast event including content assets for display with broadcast content, comprising:
creating an episode file with a number of content assets, each asset including one or more of text, graphics, video, and functionality; and
associating each content asset with a location in a script and/or pre-finalized version of the broadcast event.

22. The method of claim 21, further comprising, when the broadcast event content is finalized, associating the content assets with a time code in the broadcast event.

23. The method of claim 21, wherein the broadcast event is over television.

24. The method of claim 21, wherein the broadcast event is over radio.

25. The method of claim 21, wherein the broadcast event is over the Internet.

26. The method of claim 21, wherein the content assets are displayed at the user end on the same display as the broadcast content.

27. A system for creating an interactive broadcast event including content assets for display with broadcast content, comprising:
storage with an episode file with a number of content assets, each asset including one or more of text, graphics, video, and functionality; and
a processor for associating each content asset with a location in a script and/or pre-finalized version of the broadcast event.
